(19) United States
(12) Patent Application Publication
(10) Pub. No.: US 2024/0255703 A1
(43) Pub. Date: Aug. 1, 2024

(54) OPTICAL CONNECTOR AND MANUFACTURING METHOD THEREOF

(71) Applicant: NTT ADVANCED TECHNOLOGY CORPORATION, Tokyo (JP)

(72) Inventors: Yasunari KAWASAKI, Tokyo (JP); Junya KOBAYASHI, Tokyo (JP)

(21) Appl. No.: 18/562,203

(22) PCT Filed: Mar. 17, 2022
(86) PCT No.: PCT/JP2022/012233

§ 371 Date: Nov. 17, 2023

(30) Foreign Application Priority Data
May 21, 2021 (JP) 2021-085866

(51) Int. Cl. G02B 6/32

(52) U.S. Cl. CPC G02B 6/32

(57) ABSTRACT

An optical connector (10) of the present invention includes a front-stage block (11) on which an optical fiber is mounted, a rear-stage block (12) on which a polymer waveguide is mounted, a self-forming waveguide (18) arranged between the front-stage block and the rear-stage block, the self-forming waveguide configured to connect the optical fiber and the polymer waveguide, and a cladding portion (19) formed around the self-forming waveguide, wherein the self-forming waveguide is a portion cured by irradiation of resin curing light in a self-forming waveguide material arranged between the front-stage block and the rear-stage block. Thus, the present invention can provide an optical connector that reduces a connection loss between an optical fiber and a polymer waveguide by a simple structure.

### TECHNICAL FIELD

The present invention relates to an optical connector that connects an optical fiber, an optical waveguide, and the like, and a manufacturing method thereof.

### BACKGROUND ART

As an optical waveguide connector that connects an optical waveguide such as a polymer waveguide or an optical fiber tape core wire to an optical component such as an optical fiber, an MT (Mechanically Transferable) optical connector (to be referred to as an “MT connector” hereinafter) is used. When connecting MT connectors to each other, the cores of the optical fibers of the MT connectors can be aligned using guide pins, and accurate connection in submicron level necessary for single mode connection is possible.

Non-patent literature 1 discloses an optical connector that connects an optical fiber and a polymer waveguide. In an optical connector 20, as shown in FIG. 4A, an MT connector 21 and a PMT connector 22 are connected via guide pins 24 and fixed by a clamp spring 28. Here, the PMT connector 22 is configured by fixing a polymer waveguide to a PMT ferule and polishing its end face such that it becomes a connection surface to another optical connector.

### RELATED ART LITERATURE

### Non-Patent Literature

Non-Patent Literature 1: Y. Hatakeyama et. al., “PMT connectors for multi-channel film waveguides”, Proc. of SPIE Vol. 7213 72130V-1-V-9.

### DISCLOSURE OF INVENTION

### Problem to be Solved by the Invention

In the PMT connector 22, however, as shown in FIG. 4B, when connecting the MT connector 21 in which an optical fiber is fixed to the PMT connector 22, an optical axis deviation readily occurs between an optical fiber 26 of the MT connector 21 in which the optical fiber is fixed and a waveguide 27 of the polymer waveguide of the PMT connector 22, and optical axis alignment is difficult.

More specifically, in the optical fiber 26 mounted on the MT connector 21, the accuracy between the center of the core and the outer shape (outer periphery) of the cladding, that is, the outer shape of the optical fiber is less than 1 μm (submicron). Since this accuracy is an accuracy necessary for single mode connection, the position of the core can be decided by the outer shape (dimensional accuracy) of the optical fiber.

On the other hand, the accuracy of the position of the waveguide 27 of the polymer waveguide mounted on the PMT connector 22 is decided by the dimensional accuracy (tolerance) of the fixing portion of the polymer waveguide in the PMT connector 22. Here, since the dimensional accuracy (tolerance) of the fixing portion is about 10 μm, it is difficult to accurately decide the position of the waveguide 27 of the polymer waveguide by the outer shape (dimensional accuracy) of the polymer waveguide fixing portion.

As a result, when assembling the polymer waveguide in the PMT connector 22, it is difficult to connect the optical fiber of the MT connector 21 and the polymer waveguide of the PMT connector 22 at a high accuracy necessary for single mode connection.

To accurately connect the optical fiber of the MT connector and the polymer waveguide of the PMT connector, a special process of, for example, forming a polymer waveguide positioning mechanism (a slit or the like) in the PMT connector is needed, problematically resulting in much time and cost.

### Means of Solution to the Problem

In order to solve the above-described problem, according to the present invention, there is provided an optical connector comprising a front-stage block on which an optical fiber is mounted, a rear-stage block on which a polymer waveguide is mounted, a self-forming waveguide arranged between the front-stage block and the rear-stage block, the self-forming waveguide configured to connect the optical fiber and the polymer waveguide, and a cladding portion formed around the self-forming waveguide, wherein the self-forming waveguide is a portion cured by irradiation of resin curing light in a self-forming waveguide material arranged between the front-stage block and the rear-stage block.

In the optical connector according to the present invention, the self-forming waveguide material may be arranged to be irradiated with the resin curing light from both sides of the optical fiber and the polymer waveguide.

In the optical connector according to the present invention, a self-forming waveguide holding portion may be provided in at least one of the front-stage block and the rear-stage block.

In the optical connector according to the present invention, if the optical fiber and the polymer waveguide are arranged such that optical axes thereof do not match, the self-forming waveguide may be curved between the optical fiber and the polymer waveguide.

In the optical connector according to the present invention, a surface of the front-stage block which comes into contact with the self-forming waveguide material, may be obliquely processed.

In the optical connector according to the present invention, the optical fiber may be an optical fiber with a lens.

According to the present invention, there is also provided a manufacturing method of an optical connector that connects a front-stage block and a rear-stage block of the optical connector, comprising a step of arranging a connecting surface of the front-stage block and a connecting surface of the rear-stage block facing each other, a step of injecting a self-forming waveguide material into a self-forming waveguide material holding portion between the front-stage block and the rear-stage block; a step of causing resin curing light to exit from an optical fiber mounted on the front-stage block and a waveguide of a polymer waveguide mounted on the rear-stage block; a step of photocuring the self-forming waveguide material by irradiation of the resin curing light to form a self-forming waveguide, and a step of forming a cladding portion around the self-forming waveguide.

### Effect of the Invention

According to the present invention, it is possible to provide an optical connector capable of accurately and easily connecting a polymer waveguide with a low loss, and a manufacturing method thereof.

### BRIEF DESCRIPTION OF DRAWINGS

FIG. 1A is a bird's-eye perspective view of an optical connector according to the first embodiment of the present invention;

FIG. 1B is a top perspective view of the optical connector according to the first embodiment of the present invention;

FIG. 1C is an IC-IC′ sectional view of the optical connector according to the first embodiment of the present invention;

FIG. 2 is a bird's-eye perspective view of the optical connector according to the first embodiment of the present invention before connection;

FIG. 3A is a view for explaining a manufacturing method of the optical connector according to the first embodiment of the present invention;

FIG. 3B is a view for explaining the manufacturing method of the optical connector according to the first embodiment of the present invention;

FIG. 3C is a view for explaining the manufacturing method of the optical connector according to the first embodiment of the present invention;

FIG. 3D is a view for explaining the manufacturing method of the optical connector according to the first embodiment of the present invention;

FIG. 3E is a view for explaining the manufacturing method of the optical connector according to the first embodiment of the present invention;

FIG. 4A is a bird's-eye perspective view of a conventional optical connector; and

FIG. 4B is a side sectional view of the conventional optical connector.

### BEST MODE FOR CARRYING OUT THE INVENTION

### First Embodiment

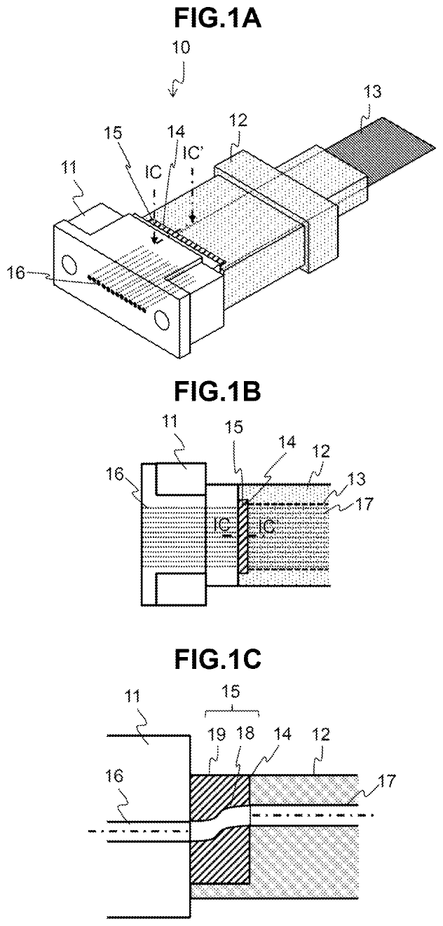

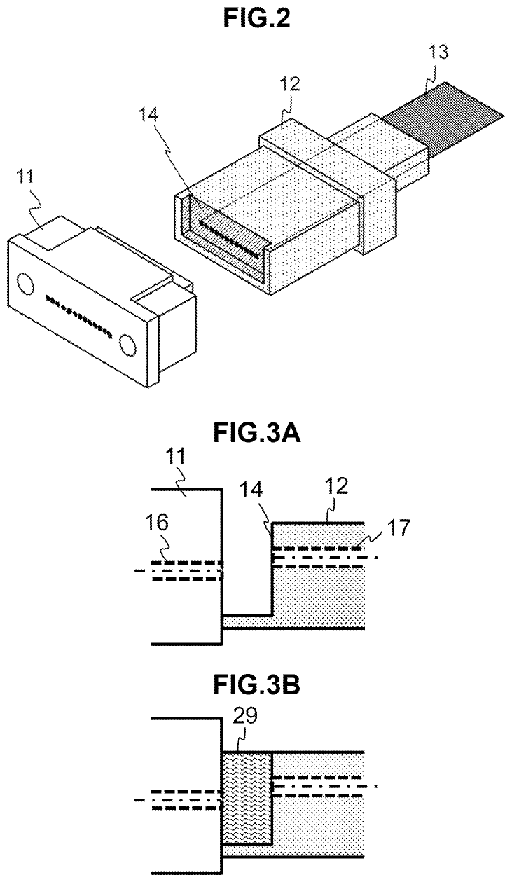

An optical connector according to the first embodiment of the present invention will be described with reference to FIGS. 1A to 2. FIGS. 1A, 1B, and 1C are a bird's-eye perspective view, a top perspective view, and an IC-IC′ sectional view of an optical connector 10 according to this embodiment, respectively. FIG. 2 shows the state of the optical connector 10 before connection.

### <Structure of Optical Connector>

The optical connector 10 includes a front-stage block 11, a rear-stage block 12, a polymer waveguide 13, a self-forming waveguide material holding portion 14, and a self-forming waveguide portion 15.

In the front-stage block 11, one or a plurality of optical fibers 16 are mounted, and an end face to be connected to another optical connector is polished. The surface on the opposite side of the end face to be connected to another optical connector may be polished at 0° or obliquely. Alternatively, the surface may be a 0° or oblique cleavage plane of the optical fiber. Here, the angle of oblique polishing in the front-stage block 11 and the angle of the oblique cleavage plane of the optical fiber are normally about 8º, and preferably 10° or less. The front-stage block 11 connects the mounted optical fibers 16 to optical fibers in another connector with a low loss at a submicron accuracy.

The rear-stage block 12 includes a polymer waveguide fixing portion that fixes the polymer waveguide 13. The polymer waveguide 13 is fixed in the rear-stage block 12 at an accuracy of about 10 μm. The end face of the polymer waveguide 13 is formed by, for example, dicing. The polymer waveguide 13 is fixed by, for example, an adhesive. If an adhesive whose refractive index after curing is close to the refractive index of the polymer waveguide core portion is used, the adhesive can reach the end face portion of the polymer waveguide 13.

The rear-stage block 12 includes the self-forming waveguide material holding portion 14, as shown in FIG. 2. The self-forming waveguide material holding portion 14 is a concave portion formed in the connecting surface of the rear-stage block 12 to the front-stage block 11 and has side surfaces and a bottom surface. When forming a self-forming waveguide, a self-forming waveguide material (for example, a photocuring resin) is injected into the self-forming waveguide material holding portion 14 (to be described later).

In this embodiment, the self-forming waveguide material holding portion 14 is formed in the rear-stage block 12. However, the self-forming waveguide material holding portion 14 may be formed in the front-stage block 11, or may be formed in both the front-stage block 11 and the rear-stage block 12.

The self-forming waveguide portion 15 includes a self-forming waveguide 18, and a cladding portion 19 around the self-forming waveguide 18, and is formed between the front-stage block 11 and the rear-stage block 12.

The self-forming waveguide 18 is formed in a portion of the photocuring resin where the refractive index is changed by irradiation of resin curing light. The resin curing light is light for curing the photocuring resin. As shown in FIG. 1C, the self-forming waveguide 18 connects the optical fiber 16 in the front-stage block 11 and a waveguide 17 of the polymer waveguide in the rear-stage block 12.

The cladding portion 19 is formed between the front-stage block 11 and the rear-stage block 12 by, for example, applying a cladding material to cover the self-forming waveguide 18. As a result, the cladding portion 19 is arranged around the self-forming waveguide 18.

In this embodiment, an example in which a photocuring resin is used as the material of the self-forming waveguide 18 (to be referred to as a “self-forming waveguide material” hereinafter) has been described. However, any material whose refractive index is changed by light irradiation can be used.

In this way, the optical fiber 16 in the front-stage block 11 and the waveguide 17 of the polymer waveguide in the rear-stage block 12 can be connected by the self-forming waveguide 18 with a low loss.

### <Manufacturing Method of Optical Connector>

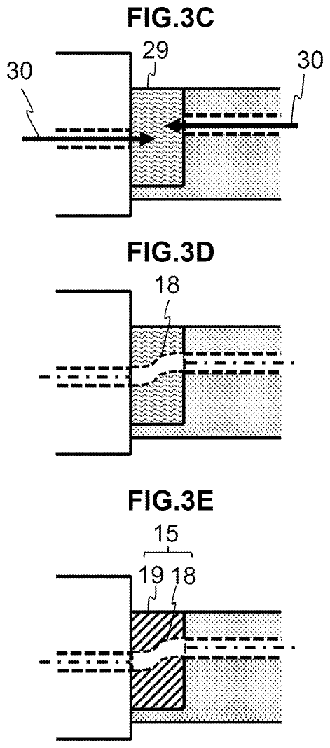

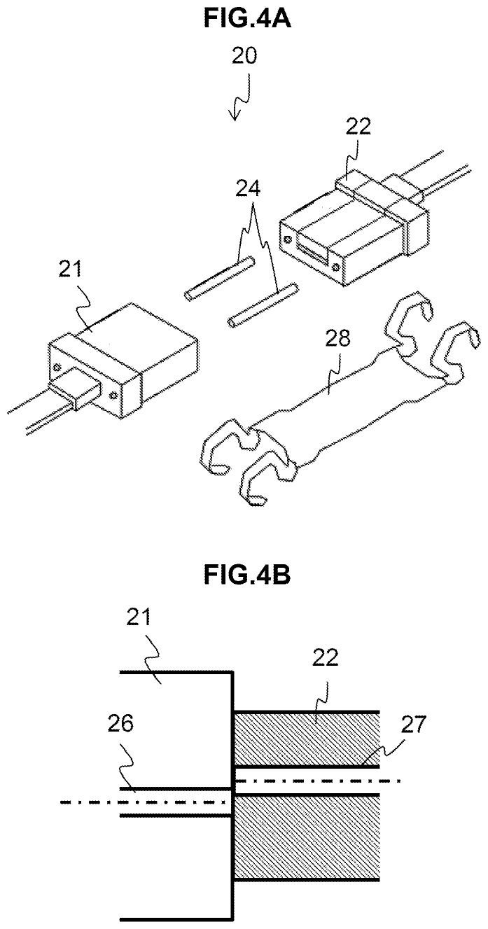

A manufacturing method of the optical connector 10 according to this embodiment will be described with reference to FIGS. 3A to 3E. FIGS. 3A to 3E are side sectional views of the optical connector showing manufacturing steps of the optical connector 10.

First, the connecting surface of the front-stage block 11 and the connecting surface of the rear-stage block 12 are arranged such that these face and are connected. Here, the self-forming waveguide material holding portion 14 is arranged between the front-stage block 11 and the rear-stage block 12 (FIG. 3A).

Next, a gel or liquid self-forming waveguide material, for example, a photocuring resin 29 is injected (arranged) in the self-forming waveguide material holding portion 14 between the front-stage block 11 and the rear-stage block 12. (FIG. 3B).

Next, resin curing light 30 exits from the optical fiber 16 in the front-stage block 11 and the waveguide 17 of the polymer waveguide in the rear-stage block 12 (FIG. 3C).

Thus, the photocuring resin 29 is irradiated with the resin curing light 30 from both sides and photocured, thereby forming the self-forming waveguide 18 (FIG. 3D).

Here, the photocuring resin 29 is sequentially cured from a portion irradiated with the resin curing light 30. As a result, in a case where the resin curing light 30 exits from both the optical fiber 16 in the front-stage block 11 and the waveguide 17 of the polymer waveguide in the rear-stage block 12, for example, even if an optical axis deviation occurs in a direction perpendicular to the optical axis direction of the optical fiber 16 and the waveguide 17 of the polymer waveguide, the self-forming waveguide 18 that is curved to compensate for the optical axis deviation is formed.

As described above, even if the optical axis of the optical fiber 16 and that of the waveguide 17 of the polymer waveguide do not match, that is, even if an optical axis deviation occurs, optical connection with a low loss can be implemented.

Next, an uncured photocuring resin is removed using a cleaning liquid such as ethanol.

Finally, a cladding material is injected around the self-forming waveguide 18, thereby forming the cladding portion 19 of the self-forming waveguide (FIG. 3E).

In this way, the optical connector 10 according to this embodiment can be manufactured—by forming the self-forming waveguide portion 15 between the front-stage block 11 and the rear-stage block 12.

In this embodiment, an example in which when forming the cladding portion, after the uncured photocuring resin is washed away, the cladding material is injected has been described. However, the present invention is not limited to this. After the self-forming waveguide 18 is formed by irradiating the photocuring resin with light, a heat treatment may be performed, and the uncured photocuring resin around the self-forming waveguide may be cured to form the cladding portion. Alternatively, the photocuring resin may be cured by irradiation of resin curing light having a wavelength different from that of the light that has cured the core portion of the self-forming waveguide, thereby forming the cladding portion.

According to the optical connector of this embodiment, the dimensional accuracy gap between the front-stage block that has a high dimensional accuracy (submicron level) and can implement single mode connection with a low loss and the rear-stage block that has a low dimensional accuracy (about 10 μm) is corrected (compensated) by the self-forming waveguide, thereby implementing single mode connection with a low loss in the optical connector in which the front-stage block and the rear-stage block are connected.

Also, since the self-forming waveguide material holding portion is provided inside the optical connector, it is possible to easily form the self-forming waveguide and form the cladding to the self-forming waveguide core.

In addition, since the self-forming waveguide material holding portion prevents an external force required for optical connector connection from being applied to the self-forming waveguide portion, the reliability of the optical connector can be ensured.

Also, according to the optical connector of this embodiment, the optical connector of single mode connection with a low loss can easily be implemented without performing a special process such as a positioning mechanism (slit) in the polymer waveguide.

In addition, according to the optical connector of this embodiment, connection with low reflection can be implemented because the optical fiber in the front-stage block and the self-forming waveguide are connected obliquely.

### Modification

An optical connector according to a modification of the first embodiment uses a fiber with a lens as an optical fiber mounted on the front-stage block.

In a case where a normal optical fiber is used, when connecting the optical connector to another optical connector, to maintain the coupling efficiency of fiber light beams, the optical connectors need to be pressed and brought into tight contact with each other using an elastic mechanism such as a spring.

According to the optical connector of this modification, fiber light beams can be coupled by the lens, and the coupling efficiency can be maintained without pressing and bringing the optical connectors into tight contact. Hence, an elastic mechanism such as a spring is unnecessary, and the optical connector can be connected to another connector with a low loss by the simple structure.

In the embodiment of the present invention, concerning the structure and the manufacturing method of the optical connector, mere examples of the structures, dimensions, and materials of the components have been described. However, the present invention is not limited to this. Any structures, dimensions, and materials capable of obtaining the function of the optical connector and exhibiting the effects are usable.

### INDUSTRIAL APPLICABILITY

The present invention can be applied to an optical connector that connects an optical waveguide to an optical component in optical communication or the like.

### EXPLANATION OF THE REFERENCE NUMERALS AND SIGNS

10 . . . optical connector, 11 . . . front-stage block, 12 . . . rear-stage block, 13 . . . polymer waveguide, 14 . . . self-forming waveguide material holding portion, 15 . . . self-forming waveguide portion, 16 . . . optical fiber core, 17 . . . polymer waveguide core, 18 . . . self-forming waveguide, 19 . . . cladding portion

1. An optical connector comprising:
a first block on which a first waveguide is mounted;
a second block on which a second waveguide is mounted;
a self-forming waveguide arranged between the first block and the second block, the self-forming waveguide configured to optically connect the first waveguide and the second waveguide; and
a cladding portion formed around the self-forming waveguide,
wherein the self-forming waveguide includes a portion cured by irradiation of resin curing light in a self-forming waveguide material arranged between the first block and the second block.

2. The optical connector according to claim 1, wherein the self-forming waveguide material is arranged to be irradiated with the resin curing light from both sides of the first waveguide and the second waveguide.

3. The optical connector according to claim 1, wherein at least one of the first block and the second block include a self-forming waveguide holding portion for holding the self-forming waveguide material thereon.

4. The optical connector according to claim 1, wherein if the first waveguide and the second waveguide are arranged such that optical axes thereof do not match, the self-forming waveguide is curved between the first waveguide and the second waveguide.

5. The optical connector according to claim 1, wherein a surface of the first block which comes into contact with the self-forming waveguide material, is obliquely processed.

6. (canceled)

7. (canceled)

8. The optical connector according to claim 1, wherein the first waveguide is an optical fiber, and
the second waveguide is a polymer waveguide.

9. The optical connector according to claim 1, wherein the first waveguide is an optical fiber with a lens.

10. A manufacturing method of an optical connector including a first block and a second block, and configured to connect a first optical waveguide mounted on the first block and a second optical waveguide mounted on the second block, comprising:
arranging the first block and the second block such that a connecting surface of the first block and a connecting surface of the second block facing each other;
injecting a self-forming waveguide material between the first block and the second block;
causing resin curing light to exit from a first waveguide mounted on the first block and a waveguide of a second waveguide mounted on the second block;
photocuring the self-forming waveguide material by irradiation of the resin curing light to form a self-forming waveguide; and
forming a cladding portion around the self-forming waveguide.
